(19) United States
(12) Patent Application Publication
(10) Pub. No.: US 2011/0244344 A1
(43) Pub. Date: Oct. 6, 2011

(54) DEVICE FOR PRODUCING GASEOUS HYDROGEN, SYSTEM FOR PRODUCING ELECTRIC POWER, AND CORRESPONDING METHOD FOR PRODUCING GASEOUS HYDROGEN

(75) Inventors: Giuseppe Emanuele SPOTO, Trecastagni (IT); Cristian DALL'OGLIO, Niscemi (IT); Andrea LAZZARA, Pedara (IT)

(73) Assignee: STMICROELECTRONICS S.R.L., Agrate Brianza (IT)

(21) Appl. No.: 13/079,581

(22) Filed: Apr. 4, 2011

(30) Foreign Application Priority Data
Apr. 2, 2010 (IT) MI2010A000563

(51) Int. Cl. H01M 8/06; B01J 8/00; C01B 3/02; F15D 1/00

(52) U.S. Cl. 429/421; 422/187; 423/648.1; 137/1

(57) ABSTRACT

An embodiment of a device for producing gaseous hydrogen comprising a reaction chamber having a solution with catalyst, a tank chamber comprising a reactant suitable for reacting with the solution with catalyst for the production of gaseous hydrogen, the tank chamber being provided with removable partition means suitable for defining a first storage chamber, for the reactant, and a second storage chamber, for the reaction by-products, the partition means being adjustable so that the volume of the first storage chamber and the volume of the second storage chamber are variable in a complementary way with respect to each other.

### PRIORITY CLAIM

The instant application claims priority to Italian Patent Application No. MI2010A000563, filed Apr. 2, 2010, which application is incorporated herein by reference in its entirety.

### TECHNICAL FIELD

An embodiment relates to the industrial field for the production of electric power in particular, but not exclusively, for portable electronic systems.

### BACKGROUND

In recent years, within this field, portable systems for the production of electric power PPS, acronym of Portable Power Supply, comprising micro fuel cells have taken an important role as alternative to the common batteries that employ electrochemical cells. The development is due both to an increasing sensitivity with regard to environmental problems and to the intrinsic energy capacity found in micro fuel cell systems.

In particular, portable systems PPS are capable of obtaining electric power through substantially a fuel oxide-reduction reaction (typically H₂) generated through hydrolysis reactions of chemical compounds. These systems also respect the environment since they produce, as reaction by-products, mainly heat and water and, at the end of their life, they do not disperse heavy metals into the environment.

The fuels or energy carriers that are most suitable for the treatment in portable systems PPS, of the type considered, are hydrogen and methanol. Hydrogen for portable applications is typically the preferred fuel since it may be stored through storage of chemical hydride under environment pressure and temperature. Hydrogen also offers, in fact, a greater flexibility than methanol, and an easy management in portable systems with high performance.

Some examples of hydrogen storage, also known as “hydrolytic systems of hydrogen storage”, are made of hydrides of alkaline metals, like for example sodium hydride NaH, calcium hydride CaH₂, hydrides of light metals, and complex hydrides, like for example sodium tetrahydroborate or Sodium Borohydride NaBH₄.

An embodiment of a system for the production of electric power with micro fuel cells is shown in FIG. 1 and described in the Italian patent application No. MI2008A002360, filed on Dec. 31, 2008, which is incorporated by reference.

The system 1 comprises a micro fuel cell 2 overlapped onto a microreactor 3 for the production of gaseous hydrogen H₂. The microreactor 3 comprises a catalyst that reacts with a solution of hydride, for example sodium tetrahydroborate NaBH₄, suitably contained in a storage tank 4 in fluid connection with the microreactor 3 through a micropump 5 piezoelectrically activated. The sodium tetrahydroborate NaBH₄, introduced into the microreactor 3, reacts according to the known exothermic formula under environmental pressure and temperature for producing gaseous hydrogen (H₂):

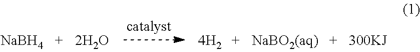

The reaction by-product or waste, and in particular the sodium borate NaBO₂ soluble in water and non polluting, is collected in a further storage tank 6 in fluid connection with the micro reactor 3 through a further micropump 7 piezoelectrically activated.

The micro fuel cell 2 by means of a polymeric membrane MEA (Membrane Electrode Assembly) made of a proton exchange central core or PEM (Proton Exchange Membrane) and two electrodes, anode A and cathode C, allows separating the gaseous hydrogen H₂ produced by the reaction (1) into protons and electrons thus generating the electric current requested.

In an embodiment, shown in FIG. 2 and described in the above identified Italian patent application, the components of the portable system PPS are suitably realized with PCB technology allowing some remarkable advantages. Among these advantages, there is the possibility to integrate, in the system, circuits of control and conditioning of the power produced, to realize an easy interfacing with other devices as well as to realize a quick prototypation that allows to generate systems on the basis of the electric power requested by the load and by the desired autonomy.

In fact, by varying the number of micro fuel cells present in the system PPS, the peak power varies and thus the system may be easily sized for supplying any type of portable electronic device: cell phones, digital video chambers (camcorders), battery-chargers, PDA (Personal Digital Assistant) and units GPS (Global Positioning System), MP3 players, consoles for videogames, notebooks and even remote sensors as well as similar applications, also employing a communication protocol of the USB type, as schematically shown in FIG. 3.

The electronic systems currently present on the market are supplied by primary and secondary batteries that, in case they have to be recharged, require the availability of the electric network.

### SUMMARY

Often, for many users, it is not possible to access a stationary energy source for recharging the primary and secondary batteries of the devices; therefore a need may arise of having systems for the production of electric power always being available.

An embodiment that may meet this need is a device for producing hydrogen and a system for producing electric power with an extremely compact structure that allows simplifying and making more efficient the management of the production of hydrogen and of electric power, as well as to have such structural and functional characteristics as to allow to improve the devices and the systems realized according to the prior art.

An embodiment is a structure with a single tank for the simultaneous storage both of the reactant and of the reaction by-products.

An embodiment is a device for producing gaseous hydrogen (H₂) comprising a reaction chamber having a solution with a catalyst, a tank chamber comprising a reactant suitable for reacting with said solution with catalyst for the production of gaseous hydrogen H₂, characterized in that said tank chamber is provided with removable partition means suitable for defining a first storage chamber, for said reactant, and a second storage chamber, for the reaction by-products, said partition means being adjustable so that the volume of said first storage chamber and the volume of said second storage chamber are variable in a complementary way with respect to each other.

Suitably, an embodiment of the device has a fluidic conduit in fluid communication between said reaction chamber and said second storage chamber for the passage of the reaction products and of the gaseous hydrogen produced in the reaction chamber.

The tank chamber may be a hollow cylindric body closed by a first end wall and by a second end wall, said removable partition means being a separation wall slidingly guided between the first end wall and the second end wall.

The fluidic conduit may be arranged internally and axially to said tank chamber with said separation wall slidingly inserted in said fluidic conduit, the first storage chamber also being interposed between the reaction chamber and the second storage chamber.

Suitably, the second end wall of the tank chamber may comprise a Gas/Liquid separator.

The reaction chamber may be a hollow cylindric body, co-axial to said tank chamber, comprising a bottom wall and a cover, said cover comprising a plurality of holes realized on the surface and arranged inside a peripheral curb, the cover defining with the first end wall a diffusion chamber for the gaseous hydrogen.

The device may also comprise a microfluidic unit interposed between said first storage chamber and said reaction chamber.

Suitably, the separation wall may have a variable position that corresponds to the level of said reactant in said first storage chamber, said separation wall being self-adjustable with the activation of said microfluidic unit.

Another embodiment is a system for producing electric power comprising at least one micro fuel cell associated with a device for producing gaseous hydrogen H₂ of the above indicated type.

Another embodiment is a method for producing gaseous hydrogen comprising the steps of storing in a tank chamber a reactant and of making a solution with catalyst react with said reactant for producing gaseous hydrogen and reaction by-products; characterized in that it comprises the step of executing a partition of said tank chamber by means of removable partition means for defining a first storage chamber, for the storage of said reactant, and a second storage chamber, for the storage of said reaction by-products; during said step of making a solution with catalyst react with said reactant, regulating said partition means so that the volume of said first storage chamber and the volume of said second storage chamber are variable in a complementary way with respect to each other.

Characteristics and advantages of embodiments of a device for producing gaseous hydrogen, of a system for producing electric power, and of a corresponding method for producing gaseous hydrogen will be apparent from the following description, which is given by way of indicative and non limiting example with reference to the annexed drawings.

### BRIEF DESCRIPTION OF THE DRAWINGS

In these drawings:

FIG. 1 shows a view of an embodiment of a system for producing electric power;

FIG. 2 shows an exploded view of an embodiment of the system shown in FIG. 1;

FIG. 3 shows a view of an embodiment of the portable system of FIG. 2 connected to portable electronic devices;

FIG. 4 shows a perspective view of a system for producing electric power according to an embodiment;

FIGS. 5 and 6 show an embodiment of the system shown in FIG. 4 respectively in a perspective, exploded view and in a section view realized along a vertical and axial plane with respect to the representation of FIG. 4;

FIGS. 7, 8 and 9 show a section view of an embodiment of the system shown in FIG. 4 respectively in an initial step of production of electric power with charged device, in an intermediate step and in a final step with uncharged device;

FIG. 10 shows an embodiment of the device of FIG. 8 in an operation upturned arrangement;

FIG. 11 shows a perspective view of a piezoelectrically activated micropump of the type used in a system according to an embodiment.

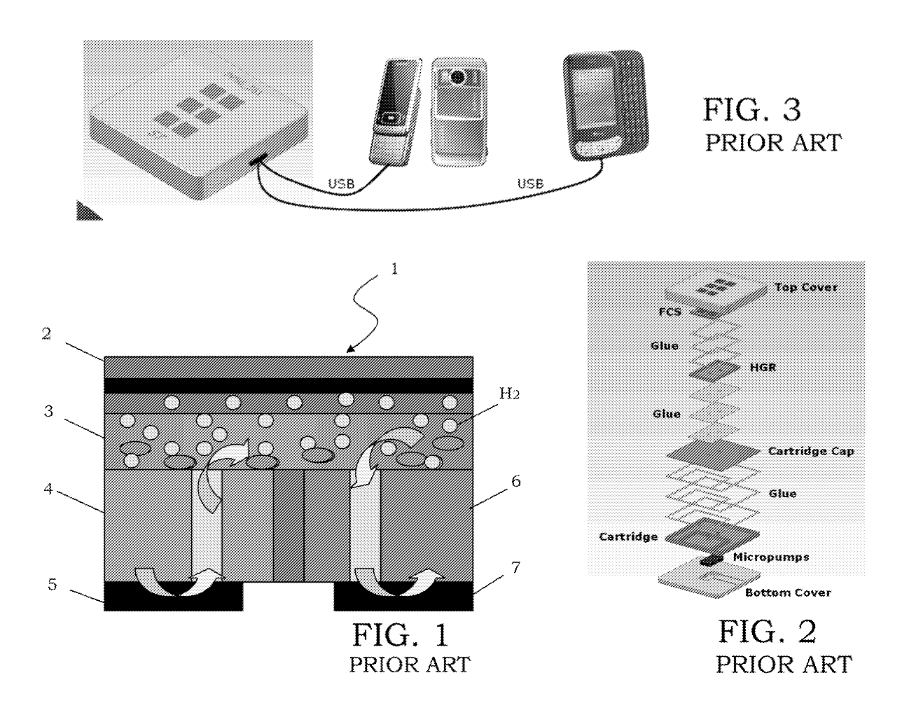

### DETAILED DESCRIPTION

With reference to these figures, 10 globally and schematically indicates a portable system for producing electric power, realized according to an embodiment and employed for supplying portable electronic systems.

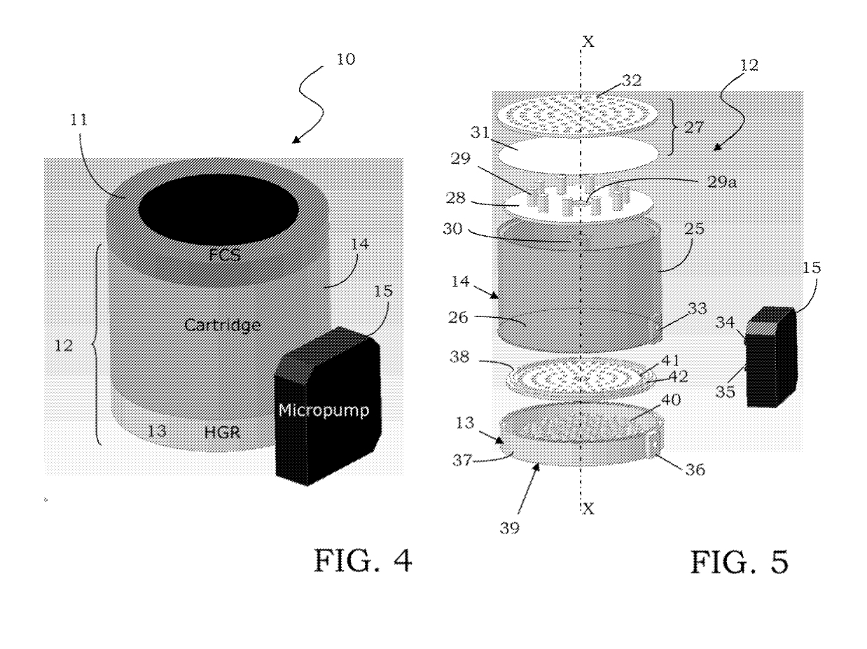

The system 10, according to an embodiment shown in FIG. 4, comprises a micro fuel cell 11, or FCS Fuel Cell System, for the production of electric power suitably supplied by a device 12 for producing gaseous hydrogen H₂.

In particular, the micro fuel cell 11 may be of the planar type preferably, but not exclusively, realized in PCB technology and comprising a polymeric electrolyte.

The device 12 substantially comprises a reaction chamber 13, containing a solution with catalyst, overhung by a tank chamber 14 comprising a reactant. Moreover, a microfluidic unit 15 of the piezoelectric type is interposed between the tank chamber 14 and the reaction chamber 13 for sending the reactant from the tank chamber 14 to the reaction chamber 13.

According to an embodiment, the device 12 comprises a single tank chamber 14 realized so as to execute the storage both of the reactant and of the reaction by-products.

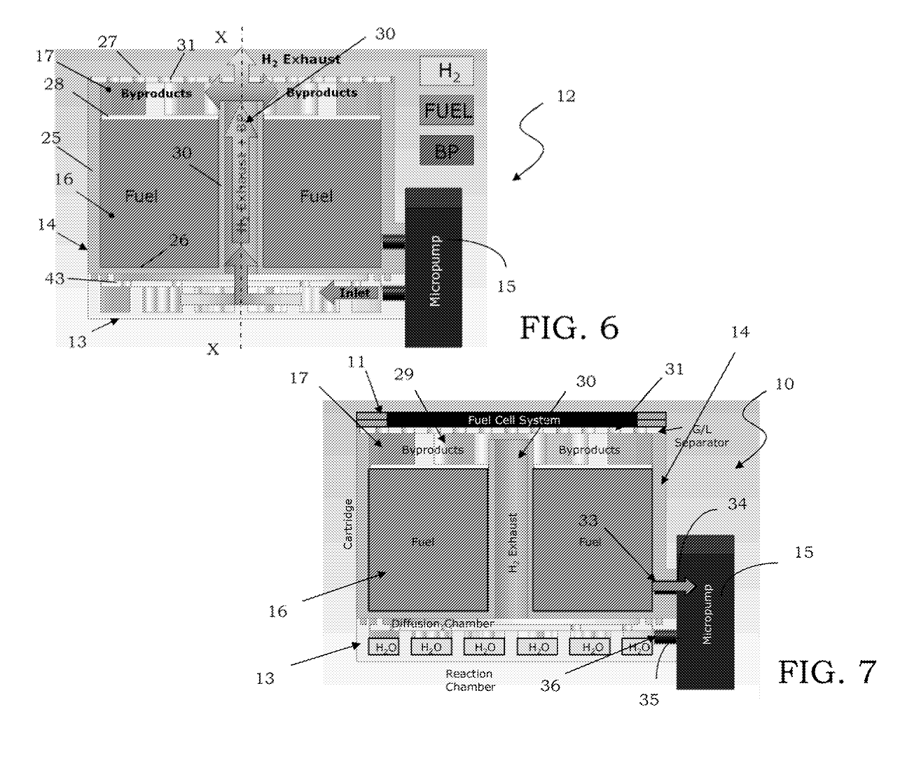

In particular, the tank chamber 14 is provided with removable partition means 28 (FIG. 5) suitable for separating the volume of the tank chamber 14 for defining a first storage chamber 16 (FIG. 6) and a second storage chamber 17 being distinct and with variable volume. The partition means 28 are regulated so that the volume of the first storage chamber 16 and the volume of the second storage chamber 17 are variable in a complementary way with respect to each other.

In an embodiment shown in FIG. 5, the tank chamber 14 is a hollow body with axis X-X comprising a side wall 25 closed at the ends by a first end wall 26 and by a second end wall 27.

According to an embodiment, as shown with reference to FIGS. 6 and 7, the partition means 28 are realized by means of a mobile separation wall 28 that is slidingly guided between the first end wall 26 and the second end wall 27. In particular, the first storage chamber 16 is defined between the first end wall 26 and the separation wall 28, while the second storage chamber 17 is defined between the separation wall 28 and the second end wall 27. The first storage chamber 16 contains the reactant and is neatly separated from the second storage chamber 17 that, may contain the reaction by-products.

The first storage chamber 16 and the second storage chamber 17 thus have volumes being complementary with respect to each other so that by shifting the separation wall 28 so as to reduce the volume of the first storage chamber 16, the volume of the second storage chamber 17 is increased in a corresponding way. In other words, the first storage chamber 16 reduces while the second storage chamber 17 expands by a same volume, or vice versa.

The separation wall 28 is substantially a tight circular plate that has size characteristics and chemical physical properties to provide a liquid-tight or fluid-tight seal that prevents the reactant, contained in the first storage chamber 16, from mixing with the reaction by-products contained in the second storage chamber 17, and vice versa.

The separation wall 28 also has spacer elements 29 arranged in the direction of the second end wall 27 so as to define a minimum volume of the second storage chamber 17 during assembly. In an embodiment of FIG. 5, these spacer elements 29 are small cylinders arranged in a regular way, for example spaced, along a circular path concentric and internal with respect to the perimeter of the separation wall 28. These spacer elements 29 are realized, according to an embodiment, for example, but not exclusively, in plastic material, as may be the separation wall 28.

The device 12 also comprises an output fluidic conduit 30, preferably but not exclusively realized as a hollow cylindric body, interposed and in fluid connection between the reaction chamber 13 and the second storage chamber 17 and suitable for allowing the passage of the reaction products.

In particular, the fluidic conduit 30 is arranged internally and axially along the axis X-X of the tank chamber 14 and has a length substantially equal to the height of the side wall 25.

The fluidic conduit 30 is inserted in the separation wall 28 in correspondence with a hole 29a and this separation wall 28 flows axially along the fluidic conduit 30, suitably moved in a substantially autonomous way with a position regulated by the level of reactant contained in the first storage chamber 16. In this way the fluidic conduit 30, above the separation wall 28, flows inside the second storage chamber 17.

The second end wall 27 of the tank chamber 14 may be realized by overlapping a Gas/Liquid separator 31 associated with a diffuser 32.

The Gas/Liquid separator 31 may be a membrane that allows separating the gaseous reaction products from the liquid ones that flow from the reaction chamber 13 through the fluidic conduit 30. In particular, the gaseous hydrogen H₂ passes through the membrane reaching the micro cell 11, while the liquid by-products are detained by the Gas/Liquid separator 31 and thus stored in the second storage chamber 17.

The diffuser 32 coupled to the Gas/Liquid separator 31 has a disc-like shape and comprises a plurality of holes arranged in a regular way, for example spaced and arranged along concentric circular paths.

According to an embodiment, the diffuser 32 is realized in plastic material or alternatively in PCB and has the double function of sustaining the membrane MEA (Membrane electrode assembly) of the system of fuel cells and also of improving, through the holes realized, the diffusion of the gaseous hydrogen H₂ produced in a substantially regular way on the whole active surface of this membrane MEA.

The tank chamber 14 also has an output conduit or outlet 33 realized in the side wall 25 in correspondence with the first storage chamber 16, for example next to the first end wall 26. The outlet 33 allows a quick connection to a counter-shaped suction mouth 34 arranged in the microfluidic unit 15. The microfluidic unit 15 also has a delivery mouth 35 of quick connection to a counter-shaped input conduit or inlet 36 arranged in the reaction chamber 13 for the passage of the reactant from the tank chamber 14, and in particular from the first storage chamber 16, to the reaction chamber 13.

The reaction chamber 13 is a hollow cylindric body, co-axial to the tank chamber 14, comprising a side wall 37 closed by a bottom wall 39 and by a cover 38.

The reaction chamber 13 comprises a catalyst 40 that may be in the form of pellets or of grains having a suitable magnitude pre-defined on the basis of the chemical physical properties of the catalyst 40 itself. The reaction chamber 13 may also contain water used for optimizing the diffusion of the solution on the surface of the catalyst 40.

The cover 38 comprises a plurality of holes 41 arranged in a regular way, for example spaced, along concentric circular paths realized inside a peripheral curb 42, which defines substantially a spacer.

By overlapping the tank chamber 14 onto the reaction chamber 13, the plurality of holes 41 as well as the curb 42 abutted against the first end wall 26 allow to realize a diffusion chamber 43 of the gaseous hydrogen H₂ generated inside the reaction chamber 13, before the same is introduced inside the fluidic conduit 30, as schematically shown in FIGS. 6 and 7.

In an embodiment, the reaction chamber 13, the tank chamber 14 and the micro fuel cell 11 have identical external sizes and may be suitably stacked, in a compact way, having on the facing walls counter-shaped edges with prearranged joint couplings possibly forming seals with each other.

According to an embodiment, the tank chamber 14 comprises as a reactant a solution of sodium tetrahydroborate NaBH₄ with high energy density, for example equal to 2500 Wh/l, stored in the first storage chamber 16.

With the activation of the microfluidic unit 15, a defined amount of solution of sodium tetrahydroborate NaBH₄ is introduced into the reaction chamber 13 and reacts with a solution comprising the catalyst 40 contained in the reaction chamber 13.

According to the formula (1) above indicated, gaseous hydrogen H₂ and reaction by-products are thus generated and both pushed in an autonomous way towards the fluidic conduit 30 for being conveyed into the second storage chamber 17.

The gaseous hydrogen H₂ passing through the Gas/Liquid separator 31 and thus through the diffuser 32 it reaches the micro fuel cell 11 overlapped onto the device 12 for producing gaseous hydrogen for generating an electric current, while the reaction by-products are stored in the second storage chamber 17.

The position of the mobile separation wall 28 is regulated by the level and thus by the amount of reactant contained in the first storage chamber 16, in a substantially automatic way. With the activation of the microfluidic unit 15 and a lowering of the level of reactant in the first storage chamber 16, the separation wall 28 regulates itself by moving in the direction of the first end wall 26 with a reduction in volume of the first storage chamber 16 and a corresponding increase in volume of the second storage chamber 17.

In this way, the volume of the first storage chamber 16 and of the second storage chamber 17 are simultaneously adjustable on the basis of the position of the separation wall 28.

The shift of the separation wall 28 thus allows an immediate adaptation of the shelter volume for the reaction by-products corresponding to the volume initially occupied by the reactant.

Operation is now described of the portable system 10 for producing electric power according to an embodiment.

In the initial charging step, as shown in FIG. 7, the system 10 is ready for producing electric power, the first storage chamber 16 is at its maximum volume with the maximum amount of reactant, while the second storage chamber 17 is empty. In particular, in relation to the height of the separator elements 29, the second storage chamber 17 has a minimum volume for the storage of the reaction by-products that flow from the fluidic conduit 30 at the actuation of the microfluidic unit 15.

The microfluidic unit 15 is connected to the device 12 with the suction mouth 34 connected to the outlet 33 of the tank chamber 14 and the delivery mouth 35 connected to the inlet 36 of the reaction chamber 13.

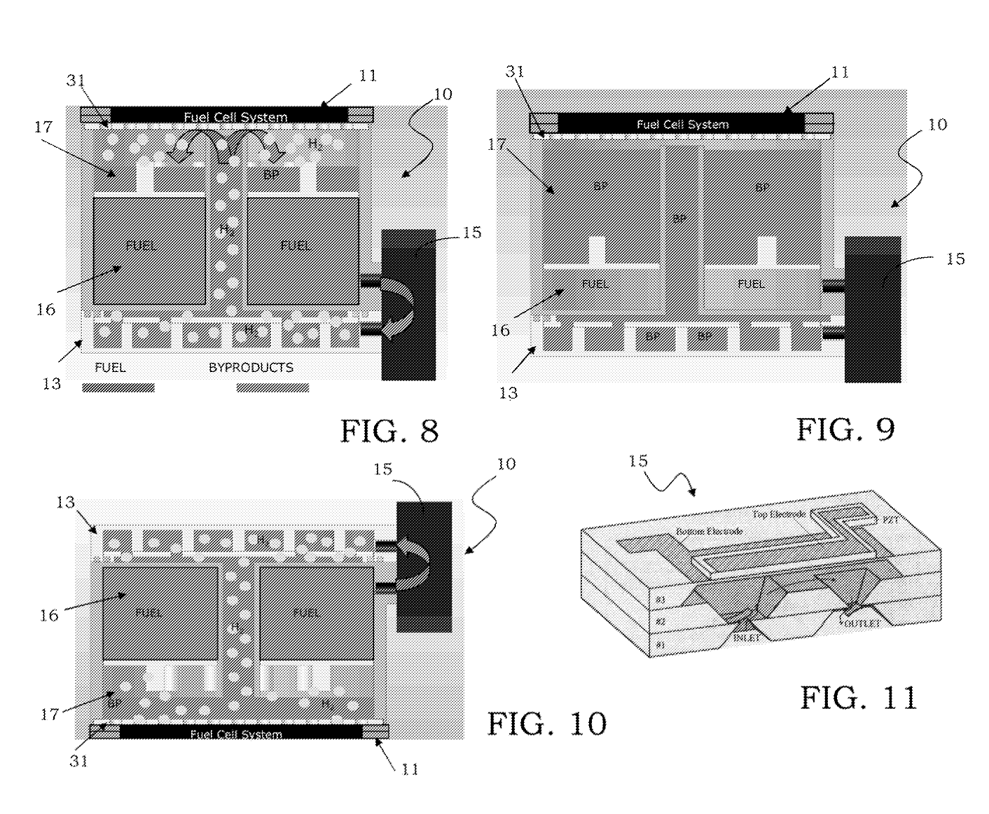

In a step of production of gaseous hydrogen H₂ and thus of electric power, as shown in FIG. 8, the microfluidic unit 15 is activated by means of prearranged and connected control circuits and the reactant passes from the first storage chamber 16 to the reaction chamber 13. The pump rate of the microfluidic unit 15 may be modulated, for example according to the supply voltage of the same microfluidic unit 15.

As soon as the reactant, for example, a solution of sodium tetrahydroborate NaBH₄, comes in contact with the catalyst contained in the reaction chamber 13, it reacts according to the formula (1) above indicated generating gaseous hydrogen H₂ and reaction by-products, mainly sodium borate NaBO₂. The water possibly present in the reaction chamber 13 may optimize the diffusion of the solution on the surface of the catalyst.

Moreover, the gaseous hydrogen H₂ generated in the reaction chamber 13 also favors the mixing, and thus the diffusion, of the reactant with the solution, water and catalyst, inside the reaction chamber 13 itself, optimizing thus in an autonomous way the reaction (1).

When the amount of reactant inserted in the reaction chamber 13 exceeds the volume of the reaction chamber 13 itself the reaction products i.e. the gaseous hydrogen H₂ and the reaction by-products are ejected from the reaction chamber 13 through the fluidic conduit 30. On top of the fluidic conduit 30, while the reaction by-products are blocked by the Gas/Liquid separator 31 and are stored in the second storage chamber 17, the gaseous hydrogen H₂ reaches the anode of the micro fuel cell 11 passing through the Gas/Liquid separator 31 and possibly through the diffusion chamber of hydrogen created in correspondence with the diffuser 32.

Inside the reaction chamber 13 and the fluidic conduit 30 there are substantially two-phase components: liquid and gas. Due to the configuration of the system 10 according to an embodiment, if the pressure of the gaseous hydrogen H₂ quickly pushes the reaction by-products into the fluidic conduit 30, these have an impact, however, against the Gas/Liquid separator 31 and cannot reach the micro fuel cell 11, ensuring thus its operation.

Moreover, thanks to the autonomous shift of the mobile separation wall 28 in relation to the level of the reactant contained in the first storage chamber 16, during the operation step as soon as the reactant is injected into the reaction chamber 13, the volume of the first storage chamber 16 decreases and the volume of the second storage chamber 17 increases in a corresponding way.

In this way, the second storage chamber 17 has an expansion always suitable with respect to the amount of reaction by-products generated, this expansion corresponding to the volume initially occupied by the reactant.

A suitable command of the microfluidic unit 15, during the step of production of the system 10, allows to regulate the flow of the reactant into the reaction chamber 13. This regulation depends on the needs of electric power as well as on the progress of the reaction inside the reaction chamber 13. Moreover, a temporary block of the microfluidic unit 15 allows to block the transfer of reactant, blocking the production of gaseous hydrogen H₂ and thus the corresponding production of electric power that may be subsequently activated according to the application. This allows, in particular, to generate a system HOD, acronym of the English “Hydrogen On Demand”.

In a final uncharging step, shown in FIG. 9, the reactant is completely transferred to the reaction chamber 13 and thus the system exclusively comprises the gaseous hydrogen H₂ and the hydrolysis reaction by-products that occupy, besides the wholeness of the volume of the reaction chamber 13, also the output fluidic conduit 30 as well as almost completely the volume of the first storage chamber 16 originally occupied, during the initial step, by the reactant.

At the end of the use of the device 12 there thus may a recovery of volume in the tank chamber 14 that corresponds almost to 50% with respect to the implementations that employ two tank chambers, this naturally due to a compactness and an easiness of management of the device 12 and of the system 10 realized according to an embodiment.

According to an embodiment, as shown in FIG. 10, the device 12 and the system 10 are independent from the orientation, i.e. they operate correctly also upturned. This remarkable advantage is obtained thanks to the particular shape of the device 12 according to an embodiment. In fact, the fluid-dynamic seal, ensured by the friction of the separation wall 28 with the side wall of the tank chamber 14, avoids the mixing of the reactants with the reaction by-products. Moreover, the presence of the gas/liquid separating membrane 31, allows the sole gaseous hydrogen H₂ produced to flow from the device 12, for supplying the system of fuel cells, and in the meantime to detain the reaction by-products, in liquid form, in the suitable storage tank 17 that, in the meantime, has increased the volume thanks to the shift of the separation wall 28.

All the components of the system 10 for producing electric power and of the device 12 for producing gaseous hydrogen H₂ may be realized in plastic material or other low cost material, according to the application.

Moreover, the micro fuel cell 11 may be realized by employing the PCB technology (Printed Circuit Board) widely developed for realizing the printed circuits and that allows to realize low cost systems of fuel cells by employing manufacturing techniques like the quick prototypation.

The system 10, according to an embodiment, is an excellent reserve of electric power where the distribution network of the same is not available.

Moreover, the system 10 may be thought of as a single unit comprising the device 12, the micro cell 11 as well as the microfluidic unit 15 and possibly the regulator and control circuitry.

Otherwise, a structure may be provided, comprising the microfluidic unit 15 and the regulator and control circuitry, which is connected to a disposable cartridge comprising a device 12 assembled to a micro cell 11.

In this case, the outlet 33 and the inlet 36 are closed by respective diaphragms that are shattered or otherwise opened when the cartridge is inserted in the portable structure by connecting to them the suction and delivery mouth, 34 and 35, of the microfluidic unit 15. This connection may be executed in a univocal way given the position of the outlet 33 and of the inlet 36. As soon as the diaphragms present in the cartridge are shattered, the reactant contained in the first storage chamber 16 fills in the suction mouth 34 of the microfluidic unit making the system 10 ready for the production of electric power by means of the activation of the microfluidic unit 15.

In an embodiment, the microfluidic unit 15 is of the piezoelectric type, as schematically shown in FIG. 11, comprising inside some of the (cantilever) check valves that ensure the absence of inverse motion of the reactant inside the body of the microfluidic unit 15 or pump, even in case of absence of its supply.

Naturally, the device 12 for producing hydrogen H₂ according to an embodiment could be employed with one or more micro fuel cells.

An embodiment also relates to a method for producing gaseous hydrogen by means of a device as previously described for which details and cooperating parts having the same structure and function will be indicated with the same reference numbers and acronyms.

Suitably, a device 12 for producing gaseous hydrogen H₂ is of the type comprising a reaction chamber 13 having a solution with catalyst and a tank chamber 14 comprising a reactant suitable for reacting with the solution with catalyst for the production of gaseous hydrogen H₂.

A method, according to an embodiment, comprising the step of storing in the tank chamber 14 a reactant and the step of making the solution with catalyst react with the reactant for producing in the reaction chamber 13 gaseous hydrogen H₂ and reaction by-products.

Suitably, the method also comprises the step of:
executing a partition of the tank chamber 14 by means of removable partition means 28 for defining a first storage chamber 16, for the storage of the reactant, and a second storage chamber 17, for the storage of the reaction by-products.

A method, according to an embodiment, during the step of making the solution with catalyst react with the reactant, provides the step of regulating the partition means 28 so that the volume of the first storage chamber 16 and the volume of the second storage chamber 17 are variable in a complementary way with respect to each other.

Further, the method provides to put in flow communication the reaction chamber 13 and the second storage chamber 17 by means of a fluidic conduit 30, arranged inside the tank chamber 14 with partition means 28 slidingly associated therewith.

According to an embodiment, a method provides that the partition means 28 are self-adjustable, i.e. they may slide in an autonomous way without the help of driving elements but regulated expressly by the volume of the first storage chamber 16 and of the second storage chamber 17.

A method provides also to associate with the tank chamber 14 a Gas/Liquid separator 31 and possibly to associate with the Gas/Liquid separator 31 a diffuser 32, so that the gaseous hydrogen H₂ produced may pass through the diffuser 32 for reaching the micro cell 11, while the liquid by-products may be detained by the Gas/Liquid separator 31 and then stored in the second storage chamber 17.

A method also provides the step of arranging the first storage chamber 16 in fluid communication with the reaction chamber 13 by associating between the same a microfluidic unit 15. Suitably, according to an embodiment, the partition means 28 correctly position themselves on the basis of the amount of reactant and on the basis of the amount of the reaction by-products according to their respective variation followed by the activation of the microfluidic unit 15.

According to an embodiment, the partition means 28 are realized by means of an internal separation wall of the tank chamber 14, that has prearranged size characteristics and chemical physical properties suitable for allowing a guarantee of a seal to allow the liquids to avoid that the reactant, contained in the first storage chamber 16, may be mixed with the reaction by-products contained in the second storage chamber 17, and vice versa.

An advantage of a device and of a system according to an embodiment is the compactness obtained by the single tank chamber with storage chambers having a volume adjustable in a complementary way with respect to each other that allows an efficient miniaturization of the system itself.

Another remarkable advantage, according to an embodiment, is given by the easy regulation of the mobile separation wall that allows simultaneously to vary the volumes of the first storage chamber of the reactant and of the second storage chamber of the reaction by-products.

Another advantage of an embodiment is given by the easiness and reliability of the device and of the system obtained. In fact, the device and the system, according to an embodiment, are “self-emptying”, i.e. the reaction by-products are pushed in an autonomous way through the fluidic conduit by the same solution present inside the reaction chamber.

The use of a single microfluidic unit may facilitate the management of a device with respect to the known technique that employs two microfluidic units and also allows a substantial saving of the inner energy expenditures being that the amount of gaseous hydrogen produced by the two techniques may be the same.

Another potential advantage is given by the possibility to produce gaseous hydrogen and electric current by implementing the concept of HOD i.e. of “Hydrogen On Demand” with the production of hydrogen and electric current on the user's demand.

Another potential advantage is the possibility to generate a disposable device and system that is connected to a structure comprising the microfluidic unit and possibly the activation and control circuitry of the same, that allows to regulate the hydrogen produced and the electric power supplied by acting simply on the microfluidic unit.

Another potential advantage is given by the versatility of the device and system according to an embodiment, that are independent from the space orientation of the components.

Another potential advantage of an embodiment is given by the possibility to produce electric power independently from the presence of a power distribution network.

Another potential advantage of a device and of a system according to an embodiment is given by the possibility to employ a technology PCB for the realization and the mechanical assembly of the components allowing to minimize the production costs.

One with the aim of meeting incidental and specific needs, may introduce several modifications to embodiments of a device for producing gaseous hydrogen and a system for producing electric power above described, all the modifications being comprised within the scope of the disclosure.

From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

1. Device for producing gaseous hydrogen (H₂) comprising:
a reaction chamber having a solution with a catalyst;
a tank chamber comprising a reactant suitable for reacting with said solution with a catalyst for the production of gaseous hydrogen;
wherein said tank chamber is provided with removable partition means suitable for defining a first storage chamber for said reactant, and a second storage chamber, for the reaction by-products, said partition means being adjustable so that the volume of said first storage chamber and the volume of said second storage chamber are variable in a complementary way with respect to each other.

2. Device according to claim 1, further comprising a fluidic conduit in flow communication between said reaction chamber and said second storage chamber.

3. Device according to claim 2 wherein said tank chamber is a hollow cylindric body closed by a first end wall and by a second end wall, said removable partition means being a separation wall slidingly guided between said first end wall and said second end wall.

4. Device according to claim 3 wherein said fluidic conduit is arranged internally and axially to said tank chamber with said separation wall that is associated with said fluidic conduit smoothly, said first storage chamber being interposed between said reaction chamber and said second storage chamber.

5. Device according to claim 4 wherein said second end wall of said tank chamber comprises a Gas/Liquid separator.

6. Device according to claim 5 wherein said reaction chamber is a hollow cylindric body, co-axial to said tank chamber, comprising a bottom wall and a cover, said cover comprising a plurality of holes realized on the surface and arranged inside a peripheral curb, said cover defining with said first end wall a diffusion chamber for the gaseous hydrogen.

7. Device according to claim 1, further comprising a microfluidic unit interposed between said first storage chamber an said reaction chamber.

8. Device according to claim 7 wherein said separation wall has a position that corresponds to the level of said reactant in said first storage chamber, said separation wall being self-adjustable with the activation of said microfluidic unit.

9. Method for producing gaseous hydrogen comprising the steps of storing in a tank chamber of a device a reactant and of making a solution with a catalyst react with said reactant for producing gaseous hydrogen and reaction by-products;
executing a partition of said tank chamber by means of removable partition means for defining a first storage chamber, for the storage of said reactant, and a second storage chamber, for the storage of said reaction by-products;
during said step of making a solution with a catalyst react with said reactant, regulating said partition means so that the volume of said first storage chamber and the volume of said second storage chamber are variable in a complementary way with respect to each other.

10. An apparatus, comprising:
a tank; and
a divider moveably disposed within the tank and operable to partition the tank into a fuel chamber and a reaction-by-product chamber.

11. The apparatus of claim 10 wherein the tank is cylindrical.

12. The apparatus of claim 10 wherein the tank comprises:
an end wall adjacent to the fuel chamber; and
a conduit extending from the end wall, through the fuel chamber and the divider, and into the reaction-by-product chamber.

13. The apparatus of claim 10 wherein the tank comprises:
an end wall adjacent to the fuel chamber; and
a cylindrical conduit extending from the end wall, through the fuel chamber and the divider, and into the reaction-by-product chamber.

14. The apparatus of claim 10 wherein:
the divider comprises a center; and
the tank comprises:
an end wall adjacent to the fuel chamber and having a center; and
a cylindrical conduit extending from approximately the center of the end wall, through the fuel chamber and approximately the center of the divider, and into the reaction-by-product chamber.

15. The apparatus of claim 10 wherein:
the tank comprises a side wall; and
the divider comprises an edge that is operable to form a liquid-tight seal with the side wall.

16. The apparatus of claim 10 wherein:
the tank comprises a side wall; and
the divider comprises an edge that is operable to form a fluid-tight seal with the side wall.

17. The apparatus of claim 10 wherein the divider is disc shaped.

18. The apparatus of claim 10, further comprising:
spacers secured to the divider and extending into the reaction-by-product chamber; and
a separator disposed adjacent to an end of the tank such that the reaction-by-product chamber is disposed between the separator and the divider, the separator permeable to a gas and impermeable to a liquid.

19. The apparatus of claim 10, further comprising a gas diffuser disposed adjacent to an end of the tank such that the reaction-by-product chamber is disposed between the diffuser and the divider.

20. The apparatus of claim 10, further comprising a fuel cell operable to convert a reaction by-product from the reaction-by-product chamber into electric power.

21. The apparatus of claim 10, further comprising a fuel cell disposed adjacent to the reaction-by-product chamber and operable to convert hydrogen from the reaction-by-product chamber into electric power.

22. The apparatus of claim 10, further comprising:
a fuel cell operable to convert a reaction by-product from the reaction-by-product chamber into an input voltage; and
a regulator operable to generate a regulated output voltage from the input voltage.

23. The apparatus of claim 10, further comprising a reaction chamber.

24. The apparatus of claim 10, further comprising a reaction chamber disposed adjacent to the fuel chamber and including a reactant.

25. The apparatus of claim 10, further comprising:
a reaction chamber; and
a pump operable to transfer fuel from the fuel chamber to the reaction chamber.

26. The apparatus of claim 10, further comprising:
a reaction chamber; and
a pump disposed outside of the tank and operable to transfer fuel from the fuel chamber into the reaction chamber.

27. The apparatus of claim 10, further comprising:
a reaction chamber in communication with the reaction-by-product chamber;
a pump operable to transfer fuel from the fuel chamber to the reaction chamber at a transfer rate;
a fuel cell operable to convert a reaction by-product from the reaction-by-product chamber into an input voltage; and
a regulator operable to generate a regulated output voltage from the input voltage by controlling the transfer rate of the pump.

28. A system, comprising:
a first apparatus, comprising:
a tank;
a divider moveably disposed within the tank and operable to partition the tank into a fuel chamber and a reaction-by-product chamber; and
a fuel cell operable to convert a reaction by-product from the reaction-by-product chamber into a signal; and
a second apparatus operable to receive the signal.

29. The system of claim 28 wherein the fuel cell is operable to convert the reaction by-product into a voltage.

30. The system of claim 28 wherein the second apparatus comprises an integrated circuit.

31. The system of claim 28 wherein the second apparatus comprises a phone.

32. The system of claim 28 wherein the second apparatus comprises a computer.

33. The system of claim 28 wherein the second apparatus comprises a USB-capable apparatus.

34. The system of claim 28 wherein the second apparatus comprises a portable electronic apparatus.

35. A method, comprising:
allowing fuel to flow out from a fuel chamber such that a volume of the fuel chamber decreases; and
allowing a by-product of a reaction between the fuel and a reactant to flow into a reaction-by-product chamber such that a volume of the reaction-by-product chamber increases.

36. The method of claim 35 wherein:
allowing the fuel to flow comprises allowing the fuel to flow such that the volume of the fuel chamber creases by an amount; and
allowing the by-product to flow comprises allowing the by-product to flow such that the volume of the reaction-by-product chamber increases by the amount.

37. The method of claim 35 wherein:
allowing the fuel to flow comprises allowing the fuel to flow such that a first side of the fuel chamber moves toward a second side of the fuel chamber; and
allowing the by-product to flow comprises allowing the by-product to flow such that a first side of the reaction-by-product chamber moves away from a second side of the reaction-by-product chamber.

38. The method of claim 35 wherein allowing the fuel and by-product to flow comprises allowing the fuel and by-product to flow such that a partition between the fuel and reaction-by-product chambers moves toward a side of the fuel chamber and away from a side of the reaction-by-product chamber.

39. The method of claim 35 wherein:
allowing the fuel to flow comprises allowing the fuel to flow such that a first side of the fuel chamber moves a distance toward a second side of the fuel chamber; and
allowing the by-product to flow comprises allowing the by-product to flow such that a first side of the reaction-by-product chamber moves the distance away from a second side of the reaction-by-product chamber.

40. The method of claim 35 wherein the fuel chamber is located above the reaction-by-product chamber.

41. The method of claim 35 wherein the fuel chamber is located below the reaction-by-product chamber.

42. The method of claim 35, further comprising generating electricity with the reaction by-product.

43. A method, comprising:
changing a volume of a fuel chamber in a manner; and
changing a volume of a fuel-reaction-by-product chamber in an opposite manner.

44. The method of claim 43 wherein:
changing the volume of the fuel chamber comprises decreasing the volume of the fuel chamber; and
changing the volume of the fuel-reaction-by-product chamber comprises increasing the volume of the fuel-reaction-by-product chamber.

45. The method of claim 43 wherein changing the volume of the fuel-reaction-by-product chamber comprises changing the volume of the fuel-reaction-by-product chamber while changing the volume of the fuel chamber.

46. The method of claim 43 wherein changing the volumes of the fuel and fuel-reaction-by-product chambers comprises moving a partition between the fuel and fuel-reaction-by-product chambers.
